(19) United States
(12) Patent Application Publication
(10) Pub. No.: US 2024/0247201 A1
(43) Pub. Date: Jul. 25, 2024

(54) METHOD OF GENERATING HIGH PURITY HYDROGEN FROM PLASTIC WASTE MIXTURES WITHOUT PRODUCING CARBON DIOXIDE

(71) Applicant: EWHA UNIVERSITY-INDUSTRY COLLABORATION FOUNDATION, Seoul (KR)

(72) Inventors: Woojae KIM, Gangnam-gu (KR); Hye Rin SEO, Gumi-si (KR); Hye Min JUNG, Cheonan-si (KR); Jiwon KIM, Seodaemun-gu, Seoul (KR)

(21) Appl. No.: 18/619,268

(22) Filed: Mar. 28, 2024

Related U.S. Application Data
(63) Continuation-in-part of application No. PCT/KR2022/014735, filed on Sep. 30, 2022.

(30) Foreign Application Priority Data
Sep. 30, 2021 (KR) 10-2021-0130031
May 24, 2023 (KR) 10-2023-0066749

(51) Int. Cl. C10J 3/16; C01B 3/02; C01D 7/07; C01F 11/18

(52) U.S. Cl. CPC C10J 3/16; C01B 3/02; C01D 7/07; C01F 11/181; C01P 2006/80; C10J 2300/0946

(57) ABSTRACT

The present disclosure relates to a method of generating high-purity hydrogen from waste plastic without producing carbon dioxide. In the method of generating hydrogen according to the embodiments of the present disclosure, reactants include hydroxide, and thus, the amount and purity of the generated hydrogen increases, a reaction temperature suitable for reaching an appropriate hydrogen production rate is lowered, and the amount of generated carbon dioxide is significantly decreased.

### CROSS-REFERENCE TO RELATED APPLICATIONS

This application is a continuation in-part application of PCT Application No. PCT/KR2022/014735 filed on Sep. 30, 2022, which claims the benefit of Korean Patent Application No. KR 10-2021-0130031 filed on Sep. 30, 2021, and this application also claims the benefit of Korean Patent Application No. KR 10-2023-0066749 filed on May 24, 2023. The entire contents of the aforementioned related applications are hereby incorporated herein by reference.

### TECHNICAL FIELD

The present disclosure relates to a method of generating high-purity hydrogen from waste plastic without producing carbon dioxide.

The present disclosure was supported by the National Research Foundation of Korea (NRF) grant funded by the Korea government (MSIT) (NRF-2022R1A2C2010744); and the National Research Foundation of Korea (NRF) grant funded by the Korea government (MSIT) (NRF-2020R1A5A1019631).

### BACKGROUND

Today, mass-produced plastics are indiscriminately discarded without proper recycling or treatment, causing environmental pollution. Methods of treating waste plastic include incineration, pyrolysis, and gasification. However, incineration of waste plastic generates dioxin, which is a harmful substance, and carbon dioxide, which is a cause of global warming, during burning. In the case of pyrolysis (emulsification), it is easy to recover wax, olefin-based polymers, and monomers, but it is difficult to recover them in high purity, when non-olefin-based waste plastic is also present in the waste mixtures. Therefore, in recent years, a gasification process that facilitates the treatment of mixed waste plastic and generates fewer air pollutants has been actively developed.

During a steam reforming reaction, a gasification process, hydrocarbon or a hydrocarbon compound containing oxygen is allowed to react with steam to generate hydrogen, and during this reaction, feedstock is brought into contact with water under high temperature conditions and CO, CO₂ and H₂ gases are generated according to the following reaction scheme:

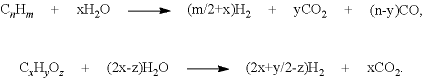

The steam reforming reaction is endothermic and thus requires heat, and the process needs to be performed at a high temperature in order to cause the reaction. Accordingly, there is a problem of high energy cost. Also, CO and CO₂ gases are generated as by-products in addition to hydrogen. Accordingly, there is a need for an additional process for separating high-purity hydrogen.

### DISCLOSURE OF THE INVENTION

### Problems to be Solved by the Invention

The present disclosure provides a method of generating high-purity hydrogen from waste plastic without producing carbon dioxide.

However, problems to be solved by the present disclosure are not limited to the above-described problems, and although not described herein, other problems to be solved by the present disclosure can be clearly understood by those skilled in the art from the following descriptions.

### Means for Solving the Problems

A first aspect of the present disclosure provides a method of generating hydrogen using plastic containing oxygen, and the method includes: subjecting the plastic containing oxygen to a thermal treatment reaction with hydroxide and water vapor to obtain hydrogen, and an amount of generated CO₂ is about 10 mol % or less of the total generated gas.

A second aspect of the present disclosure provides a method of generating hydrogen using plastic not containing oxygen, and the method includes: thermally oxidizing the plastic not containing oxygen to obtain thermally oxidized plastic; and subjecting the thermally oxidized plastic to a thermal treatment reaction with hydroxide and water vapor to obtain hydrogen.

### Effects of the Invention

In the method of generating hydrogen according to the embodiments of the present disclosure, hydroxides included as reactants increase the amount and purity of the generated hydrogen, lower the reaction temperature appropriate for hydrogen production, and significantly decrease the amount of generated carbon dioxide.

In the method of generating hydrogen according to the embodiments of the present disclosure, plastic containing oxygen is subjected to a thermal treatment reaction, and thus, carbon monoxide is generated during the reaction. Since the generated carbon monoxide and steam together form hydrogen, the amount of generated hydrogen is increased.

The method of generating hydrogen according to the embodiments of the present disclosure is performed in a low process temperature range at a high hydrogen production rate as compared to a conventional steam reforming process of plastic.

The method of generating hydrogen according to the embodiments of the present disclosure generates high-purity hydrogen as compared to the conventional steam reforming process.

In the method of generating hydrogen according to the embodiments of the present disclosure, carbon and oxygen contained in the reactants are captured in the form of solid carbonate or bicarbonate, which results in a remarkably low production amount of carbon dioxide.

The method of generating hydrogen according to the embodiments of the present disclosure uses waste plastic and requires little or extremely low raw material procurement cost and thus can economically produce hydrogen. In particular, as waste plastic, polyethylene terephthalate (PET) is one of the most widely used plastics in everyday life and can be procured in large quantities, and poly(methyl methacrylate) (PMMA) is used for specific purposes such as construction, automobiles, and electronic products and thus can be easily collected with high economic feasibility.

### BRIEF DESCRIPTION OF THE DRAWINGS

FIG. 1 is a schematic diagram illustrating processes of a method of generating hydrogen by using plastic containing oxygen according to an example of the present disclosure.

FIG. 2 is a graph showing the production amounts of gases (molar amounts of generated gases per 1 g of plastic) obtained by gasification of PMMA and PET through alkaline thermal treatment (ATT) (Example 1-1) and steam gasification (SG) (Comparative Example 1-1) according to an example of the present disclosure.

FIG. 3 is a graph showing a hydrogen gas production rate depending on a reaction temperature in gasification of PMMA and PET through ATT (Example 1-1) and SG (Comparative Example 1-1) according to an example of the present disclosure.

FIG. 4 is a graph showing a carbon dioxide gas production rate depending on a reaction temperature in gasification of PMMA and PET through ATT (Example 1-1) and SG (Comparative Example 1-1) according to an example of the present disclosure.

FIG. 5 is a graph showing the production amounts of gases obtained by gasification of PMMA and PET through ATT (Example 1-1) and gasification of polypropylene (PP) and polyethylene (PE) through ATT (Comparative Example 1-2) according to an example of the present disclosure.

FIG. 6 is a graph showing a gas production amount depending on the particle size of a plastic raw material according to an example of the present disclosure.

FIG. 7A and FIG. 7B are photos of PET raw materials used in an example of the present disclosure, and FIG. 7A is a photo of PET raw materials in the form of pellets having a diameter of 2 mm and FIG. 7B is a photo of PET raw materials in the form of powder having a diameter of 200 μm.

FIG. 8 is a graph showing the production amount of a gas obtained by gasification of epoxy resin through ATT (Example 1-2) according to an example of the present disclosure.

FIG. 9 is a graph showing a gas production rate depending on a reaction temperature in gasification of epoxy resin through ATT (Example 1-2) according to an example of the present disclosure.

FIG. 10 is a graph showing the production amount of a gas obtained by gasification of PET through ATT using Ca(OH)₂ (Example 1-3) according to an example of the present disclosure.

FIG. 11 is a graph showing a gas production rate depending on a reaction temperature in gasification of PET through ATT using Ca(OH)₂ (Example 1-3) according to an example of the present disclosure.

FIG. 12 is a graph showing a gas production rate depending on a reaction temperature in gasification of PET through SG (Example 1-3) according to an example of the present disclosure.

FIG. 13A and FIG. 13B show a gas production amount depending on a mass ratio of PMMA:NaOH in gasification of PMMA through ATT (Example 1-4) (FIG. 13A); and a gas production amount depending on a mass ratio of PET:NaOH in gasification of PET through ATT (Example 1-4) (FIG. 13B) according to an example of the present disclosure.

FIG. 14A to FIG. 14F show a gas production rate depending on a reaction temperature for each mass ratio of PMMA:NaOH in gasification of PMMA through ATT (Example 1-4) according to an example of the present disclosure.

FIG. 15A to FIG. 15F show a gas production rate depending on a reaction temperature for each mass ratio of PET:NaOH in gasification of PET through ATT (Example 1-4) according to an example of the present disclosure.

FIG. 16A and FIG. 16B are graphs showing the production amount of hydrogen depending on thermal oxidation conditions of polyethylene (PE) and polypropylene (PP) according to Example 2-1 of the present disclosure.

FIG. 17A and FIG. 17B are graphs showing the production amounts of gases depending on thermal oxidation conditions ((150° C., 50 hours) and (150° C., 100 hours)) of PE and PP according to Example 2-2 of the present disclosure.

FIG. 18A and FIG. 18B are graphs showing the production amounts of gases depending on thermal oxidation conditions ((200° C., 50 hours) and (200° C., 100 hours)) of PE and PP according to Example 2-2 of the present disclosure.

FIG. 19A and FIG. 19B are graphs showing the production amounts of gases depending on thermal oxidation conditions (100° C., 90 hours) of PE and PP according to Comparative Example 2-1 of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

In the following description, exemplary embodiments of the present disclosure will be described in detail, but the present disclosure may not be limited thereto.

A first aspect of the present disclosure provides a method of generating hydrogen using plastic containing oxygen, and the method includes subjecting the plastic containing oxygen to a thermal treatment reaction with hydroxide and water vapor to obtain hydrogen, and an amount of generated CO₂ is about 10 mol % or less of the total generated gas.

In the method according to an embodiment of the present disclosure, the amount of generated CO₂ may be about 10 mol % or less, about 9 mol % or less, about 8 mol % or less, about 7 mol % or less, about 6 mol % or less, about 5 mol % or less, about 4 mol % or less, or about 3 mol % or less of the total generated gas.

In an embodiment of the present disclosure, the method may include: supplying the plastic and the hydroxide to a reactor (a); and obtaining hydrogen and a carbonate product through a thermal treatment reaction while introducing the water vapor into the reactor (b), but may not be limited thereto. In an embodiment of the present disclosure, the process (a) may further include a process of supplying water to the reactor.

In an embodiment of the present disclosure, the carbonate product may be carbonate or bicarbonate. In an embodiment of the present disclosure, the carbonate product may include at least one selected from Na₂CO₃, K₂CO₃, Li₂CO₃, CaCO₃, MgCO₃, and (NH₄)₂CO₃, but may not be limited thereto.

In an embodiment of the present disclosure, the plastic may include at least one selected from acrylic resin, polyethylene terephthalate (PET), and epoxy resin, but may not be limited thereto. In an embodiment of the present disclosure, the acrylic resin may include a polymer formed by polymerizing one or more monomers selected from alkyl methacrylate and alkyl acrylate, but may not be limited thereto. Specifically, the monomers may include at least one selected from methyl acrylate, ethyl acrylate, propyl acrylate, butyl acrylate, isobutyl acrylate, methyl methacrylate, ethyl methacrylate, propyl methacrylate, butyl methacrylate, and isobutyl methacrylate, but may not be limited thereto. In an embodiment of the present disclosure, the acrylic resin may be poly(methyl methacrylate) (PMMA). In an embodiment of the present disclosure, the plastic may include at least one selected from PMMA and PET.

In an embodiment of the present disclosure, the hydroxide may include at least one selected from KOH, NaOH, LiOH, Ca(OH)₂, Mg(OH)₂, and NH₄OH, but may not be limited thereto.

In an embodiment of the present disclosure, the thermal treatment reaction may be performed at a temperature of about 100° C. to about 600° C., but may not be limited thereto. In an embodiment of the present disclosure, the thermal treatment reaction may be performed at a temperature of about 100° C. to about 600° C., about 150° C. to about 600° C., about 200° C. to about 600° C., about 250° C. to about 600° C., about 300° C. to about 600° C., about 100° C. to about 550° C., about 150° C. to about 550° C., about 200° C. to about 550° C., about 250° C. to about 550° C., about 300° C. to about 550° C., about 100° C. to about 500° C., about 150° C. to about 500° C., about 200° C. to about 500° C., about 250° C. to about 500° C., or about 300° C. to about 500° C., but may not be limited thereto. In an embodiment of the present disclosure, the thermal treatment reaction may be performed at a temperature of about 300° C. to about 500° C., but may not be limited thereto. In an embodiment of the present disclosure, a hydrogen generation efficiency may be high in the temperature range for the thermal treatment reaction, and the optimal temperature range may vary depending on the type of the plastic and the type of the hydroxide.

In an embodiment of the present disclosure, the thermal treatment reaction may be performed at atmospheric pressure, but may not be limited thereto.

In an embodiment of the present disclosure, a mass ratio of the plastic and the hydroxide may be about 1:2 to about 1:5, but may not be limited thereto. In an embodiment of the present disclosure, a mass ratio of the plastic and the hydroxide may be about 1:2 to about 1:5, about 1:3 to about 1:5, about 1:3.5 to about 1:5, about 1:2 to about 1:4.5, about 1:3 to about 1:4.5, or about 1:3.5 to about 1:4.5, but may not be limited thereto. In an embodiment of the present disclosure, a mass ratio of the plastic and the hydroxide may be about 1:4.

In an embodiment of the present disclosure, a purity of the hydrogen obtained by the above-described method may be about 70% or more. In an embodiment of the present disclosure, a purity of the hydrogen obtained by the above-described method may be about 70% or more, about 73% or more, about 75% or more, about 80% or more, about 85% or more, or about 89% or more. The purity of the hydrogen may indicate a ratio (unit: mol) of the hydrogen to the total product obtained by the above-described method of generating hydrogen.

In an embodiment of the present disclosure, an amount of the generated hydrogen obtained by the above-described method may be about 5 mmol or more per 1 g of plastic. In an embodiment of the present disclosure, the amount of the generated hydrogen obtained by the above-described method may be about 5 mmol or more, about 8 mmol or more, about 10 mmol or more, about 15 mmol or more, about 20 mmol or more, about 22 mmol or more, about 24 mmol or more, about 26 mmol or more, or about 28 mmol or more per 1 g of plastic.

In an embodiment of the present disclosure, an amount of generated carbon dioxide obtained by the above-described method may be less than about 1.2 mmol per 1 g of plastic. In an embodiment of the present disclosure, the amount of generated carbon dioxide obtained by the above-described method may be less than about 1.2 mmol, about 1 mmol, or about 0.7 mmol per 1 g of plastic.

A second aspect of the present disclosure provides a method of generating hydrogen using plastic not containing oxygen, and the method includes: thermally oxidizing the plastic not containing oxygen to obtain thermally oxidized plastic; and subjecting the thermally oxidized plastic to a thermal treatment reaction with hydroxide and water vapor to obtain hydrogen.

In an embodiment of the present disclosure, the plastic may be polyethylene, and the thermal oxidation may be performed at a temperature of about 150° C. to about 350° C. In an embodiment of the present disclosure, the plastic may be polyethylene, and the thermal oxidation may be performed at a temperature of about 150° C. to about 350° C., about 150° C. to about 325° C., about 150° C. to about 300° C., about 175° C. to about 350° C., about 175° C. to about 325° C., about 175° C. to about 300° C., about 200° C. to about 350° C., about 200° C. to about 325° C., about 200° C. to about 300° C., about 225° C. to about 350° C., about 225° C. to about 325° C., about 225° C. to about 300° C., about 250° C. to about 350° C., about 250° C. to about 325° C., or about 250° C. to about 300° C.

In an embodiment of the present disclosure, when the plastic is polyethylene, the thermal oxidation may be performed for about 50 hours or more, about 50 hours to about 300 hours, about 50 hours to about 200 hours, about 50 hours to about 100 hours, about 50 hours to about 90 hours, about 50 hours to about 80 hours, about 50 hours to about 70 hours, or about 50 hours to about 60 hours.

In an embodiment of the present disclosure, the plastic may be polypropylene, and the thermal oxidation may be performed at a temperature of about 150° C. to about 300° C. In an embodiment of the present disclosure, the plastic may be polypropylene, and the thermal oxidation may be performed at a temperature of about 150° C. to about 300° C., about 150° C. to about 250° C., about 150° C. to about 225° C., about 150° C. to about 200° C., about 175° C. to about 300° C., about 175° C. to about 250° C., about 175° C. to about 225° C., about 175° C. to about 200° C., about 180° C. to about 300° C., about 180° C. to about 250° C., about 180° C. to about 225° C., about 180° C. to about 200° C., about 190° C. to about 300° C., about 190° C. to about 250° C., about 190° C. to about 225° C., or about 190° C. to about 200° C.

In an embodiment of the present disclosure, when the plastic is polypropylene, the thermal oxidation may be performed for about 50 hours or more, about 50 hours to about 300 hours, about 50 hours to about 200 hours, about 50 hours to about 100 hours, about 50 hours to about 90 hours, about 50 hours to about 80 hours, about 50 hours to about 70 hours, or about 50 hours to about 60 hours.

In an embodiment of the present disclosure, the thermal treatment may include: supplying the plastic and the hydroxide to a reactor (a); and obtaining hydrogen and a carbonate product through a thermal treatment reaction while introducing the water vapor into the reactor (b). In an embodiment of the present disclosure, the process (a) may further include a process of supplying water to the reactor.

In an embodiment of the present disclosure, the carbonate product may be carbonate or bicarbonate. In an embodiment of the present disclosure, the carbonate product may include at least one selected from Na₂CO₃, K₂CO₃, Li₂CO₃, CaCO₃, MgCO₃, and (NH₄)₂CO₃, but may not be limited thereto.

In an embodiment of the present disclosure, the hydroxide may include at least one selected from KOH, NaOH, LiOH, Ca(OH)₂, Mg(OH)₂, and NH₄OH, but may not be limited thereto.

In an embodiment of the present disclosure, the thermal treatment reaction may be performed at a temperature of about 100° C. to about 700° C. In an embodiment of the present disclosure, the thermal treatment reaction may be performed at a temperature of about 100° C. to about 700° C., about 100° C. to about 650° C., about 100° C. to about 600° C., about 100° C. to about 550° C., about 200° C. to about 700° C., about 200° C. to about 650° C., about 200° C. to about 600° C., about 200° C. to about 550° C., about 250° C. to about 700° C., about 250° C. to about 650° C., about 250° C. to about 600° C., about 250° C. to about 550° C., about 300° C. to about 700° C., about 300° C. to about 650° C., about 300° C. to about 600° C., about 300° C. to about 550° C., about 350° C. to about 700° C., about 350° C. to about 650° C., about 350° C. to about 600° C., about 350° C. to about 550° C., about 400° C. to about 700° C., about 400° C. to about 650° C., about 400° C. to about 600° C., about 400° C. to about 550° C., about 450° C. to about 700° C., about 450° C. to about 650° C., about 450° C. to about 600° C., or about 450° C. to about 550° C., but may not be limited thereto. In an embodiment of the present disclosure, a hydrogen generation efficiency may be high in the temperature range for the thermal treatment reaction, and the optimal temperature range may vary depending on the type of the plastic and the type of the hydroxide. For example, the thermal treatment reaction may be efficiently performed in a narrow temperature range by performing the thermal oxidation in an appropriate temperature range.

In an embodiment of the present disclosure, the thermal treatment reaction may be performed at atmospheric pressure, but may not be limited thereto.

In an embodiment of the present disclosure, a mass ratio of the plastic and the hydroxide may be about 1:2 to about 1:6, but may not be limited thereto. In an embodiment of the present disclosure, a mass ratio of the plastic and the hydroxide may be about 1:2 to about 1:6, about 1:2 to about 1:5, about 1:3 to about 1:6, about 1:3 to about 1:5, about 1:4 to about 1:6, or about 1:4 to about 1:5, but may not be limited thereto.

In an embodiment of the present disclosure, when the plastic is polyethylene, an amount of the generated hydrogen may be about 25 mmol or more per 1 g of plastic. In an embodiment of the present disclosure, when the plastic is polyethylene, the amount of the generated hydrogen may be about 25 mmol or more, about 27 mmol or more, about 30 mmol or more, about 35 mmol or more, or about 40 mmol or more per 1 g of plastic.

In an embodiment of the present disclosure, when the plastic is polypropylene, an amount of the generated hydrogen may be about 10 mmol or more per 1 g of plastic. In an embodiment of the present disclosure, when the plastic is polypropylene, the amount of the generated hydrogen may be about 10 mmol or more, about 12 mmol or more, about 15 mmol or more, or about 17 mmol or more per 1 g of plastic.

Hereinafter, example embodiments are described in more detail by using Examples, but the present disclosure may not limited to the Examples.

### MODE FOR CARRYING OUT THE INVENTION

### Example 1-1: Gasification of Plastic (PET and PMMA) Through Alkaline Thermal Treatment (ATT)

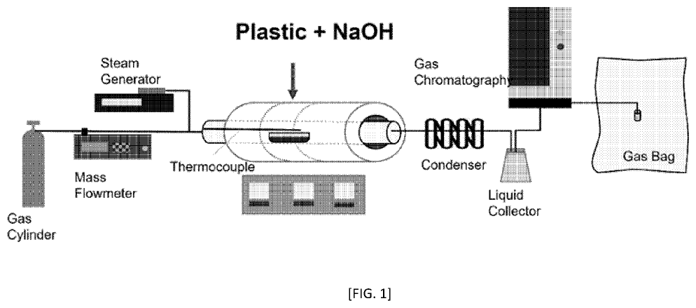

At 1 atm pressure, 0.05 g of plastic (PET or PMMA), 0.2 g of NaOH, and 0.2 g of water (H₂O) were put into a ceramic boat reactor and then, a reaction was carried out in a temperature range of 100° C. to 600° C. while 7.59 mL of steam was supplied (flow rate: 23 μL/min). Nitrogen was used as a carrier gas (flow rate: 50 mL/min), and the gas generated after the reaction was allowed to pass through a cooler, captured in a gas bag and analyzed in real time by gas chromatography (FIG. 1).

The reaction scheme of PMMA or PET, NaOH, and water during the reaction is as follows:

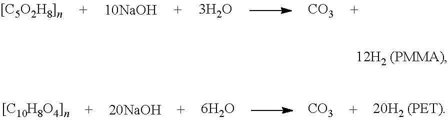

### Comparative Example 1-1: Gasification of Plastic Through Steam Gasification (SG)

When a reaction was carried out under the same conditions as in Example 1-1, plastic and water were put into a ceramic boat without the addition of a base (NaOH), followed by a steam reforming reaction. Specifically, 0.05 g of plastic (PET or PMMA) and 0.15 g of water were put into a ceramic boat reactor and then, the reaction was carried out in a temperature range of 100° C. to 600° C. while 7.59 mL of steam was supplied (flow rate: 23 μL/min).

### Comparative Example 1-2: Gasification of Plastic Through ATT for Each Type of Plastic

When a reaction was carried out under the same conditions as in Example 1-1, polypropylene (PP) and polyethylene (PE) were used as plastics. Specifically, 0.05 g of plastic (PP or PE), 0.3 g of NaOH and 0.3 g of water were put into a ceramic boat reactor and then, the reaction was carried out in a temperature range of 100° C. to 600° C. while 4.14 mL of steam was supplied (flow rate: 23 μL/min).

The reaction scheme of PP or PE, NaOH, and water during the reaction is as follows:

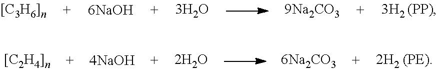

### Test Example 1-1: Comparison of Example 1-1 and Comparative Example 1-1

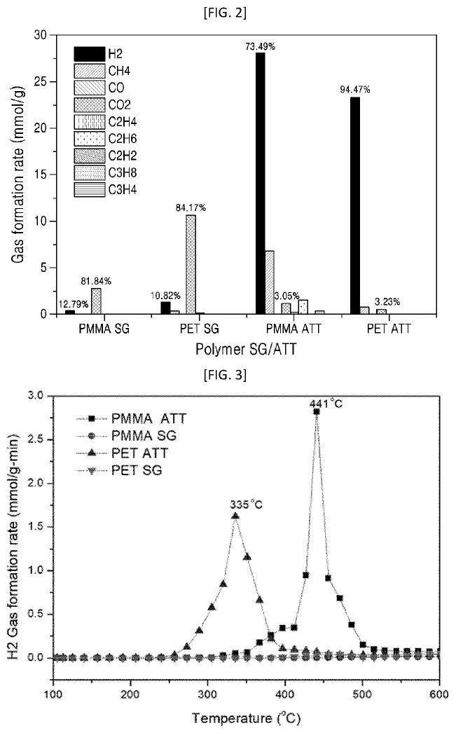

1) In Example 1-1 and Comparative Example 1-1, the gases generated at a reaction temperature of 100° C. to 600° C. were examined by gas chromatography to determine the types and production amounts of the gases (molar amounts of the generated gases per 1 g of plastic) (FIG. 2). In Comparative Example 1-1, the purities of the hydrogen gases generated from PMMA and PET were 12.79% and 10.82%, respectively. In Example 1-1 in which alkaline thermal treatment was carried out with the addition of NaOH, the purities of the hydrogen gases generated from PMMA and PET were 73.49% and 94.47%, respectively, which confirmed a remarkable increase in purity. The production amount of hydrogen generated from PMMA was 0.4327 mmol H₂/g-PMMA in Comparative Example 1-1, and increased by about 65 times to 28.1 mmol H₂/g-PMMA in Example 1-1. The production amount of hydrogen generated from PET was 1.382 mmol H₂/g-PET in Comparative Example 1-1, and increased by about 17 times to 23.39 mmol H₂/g-PET in Example 1-1. Accordingly, it was confirmed that the addition of a base (NaOH) in the thermal chemical reaction of plastic increases the purity of hydrogen in the generated gas, decreases the concentration of carbon dioxide, and increases the total production amount of hydrogen.

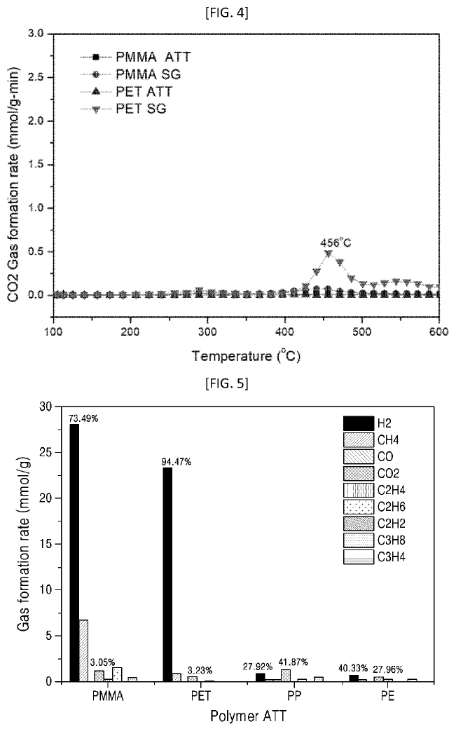

2) A hydrogen production rate depending on a reaction temperature (100° C. to 600° C.) in Example 1-1 and Comparative Example 1-1 was examined (FIG. 3). In Comparative Example 1-1, almost no hydrogen was generated over the entire temperature range (100° C. to 600° C.). In Example 1-1, the production amounts of hydrogen generated from PMMA and PET were highest at 441° C. and 335° C., respectively, and it was confirmed that the optimal reaction temperature range for PMMA was from about 350° C. to about 500° C., and the optimal reaction temperature range for PET was from about 250° C. to about 400° C. Accordingly, it was confirmed that the addition of a base (NaOH) in the thermal chemical reaction of plastic can lower a reaction temperature, which is important for achieving a constant hydrogen gas production rate.

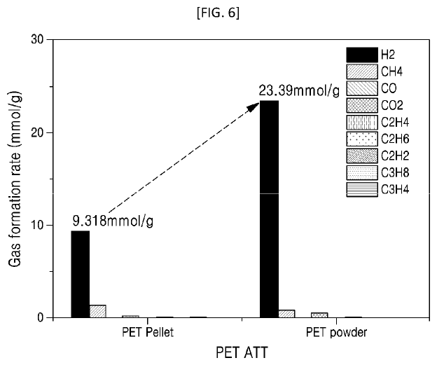

3) A carbon dioxide production rate depending on a reaction temperature (100° C. to 600° C.) in Example 1-1 and Comparative Example 1-1 was examined (FIG. 4). In Comparative Example 1-1, both PMMA and PET generated carbon dioxide at the highest production rate at about 456° C., and the production amount of carbon dioxide generated from PMMA was 2.769 mmol/g-PMMA, which is 81.84% of the total gas production amount, and the production amount of carbon dioxide generated from PET was 10.75 mmol/g-PET, which is 84.17% of the total gas production amount. In Example 1-1, the production amount of carbon dioxide generated from PMMA and PET corresponded to about 3% of the total gas production amount, and the production amount of carbon dioxide generated from PMMA was 1.165 mmol/g-PMMA and the production amount of carbon dioxide generated from PET was 0.5265 mmol/g-PET. Accordingly, it was confirmed that the presence of a base (NaOH) in the thermal chemical reaction of plastic decreases the production of carbon dioxide.

### Test Example 1-2: Comparison of Example 1-1 and Comparative Example 1-2

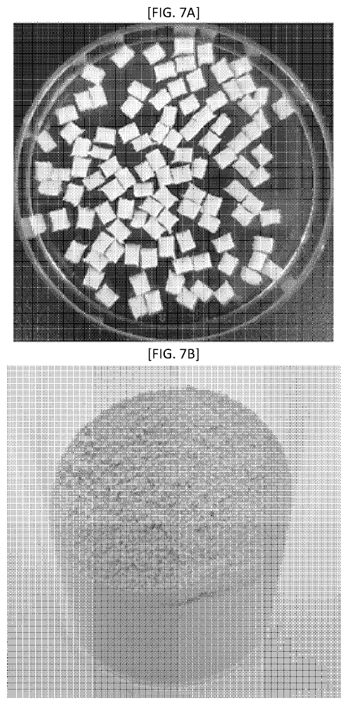

In Example 1-1 and Comparative Example 1-2, the gases generated at a reaction temperature of 100° C. to 600° C. were examined to determine the types and production amounts of the gases (molar amounts of the generated gases per 1 g of plastic) (FIG. 5). In Comparative Example 1-2, the production amounts of hydrogen generated from PP and PE were 0.857 mmol H₂/g-PP and 0.6943 mmol H₂/g-PE, respectively, and the production amounts of hydrogen generated from PMMA and PET of Example 1-1 increased by about 20 times to about 40 times to 28.1 mmol H₂/g-PMMA and 23.39 mmol H₂/g-PET, respectively. This is because the polymer containing oxygen generates carbon monoxide during the reaction, the carbon monoxide forms hydrogen together with H₂O (steam) added during the reaction, and NaOH captures CO₂ and thus forms Na₂CO₃. Accordingly, it was confirmed that PMMA and PET containing oxygen are excellent plastic materials for generating hydrogen.

### Test Example 1-3: Comparison in Generation of Hydrogen Depending on Particle Size

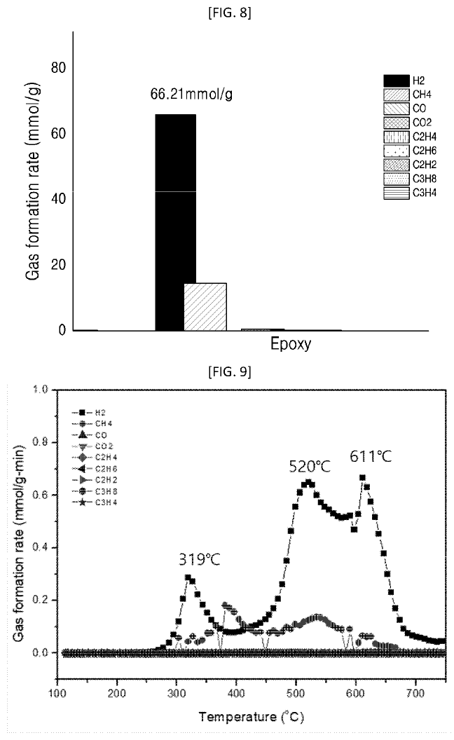

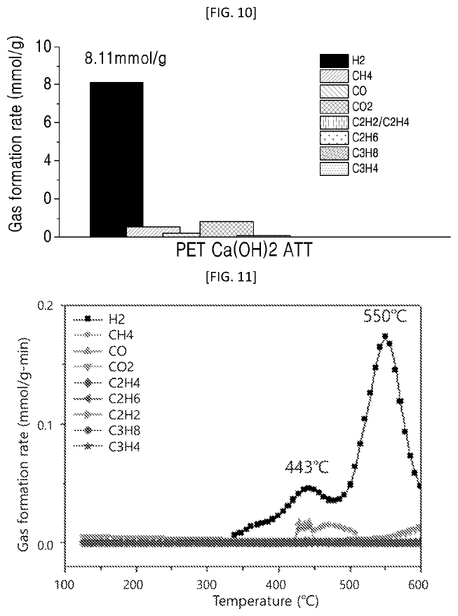

In Example 1-1, a gas production amount depending on the particle size of the raw material at a reaction temperature of 100° C. to 600° C. was examined (FIG. 6, FIG. 7A and FIG. 7B). A test was conducted under the same conditions except for the particle surface area of the raw material. FIG. 7A shows PET from Sigma Aldrich in the form of cylindrical pellets having a diameter of about 2 mm and a height of about 4 mm, and FIG. 7B shows PET in the form of powder having a diameter of less than 200 μm and obtained by pulverizing the PET pellets with a pulverizer at 25,000 rpm for 2 minutes. The generated gas captured in a gas bag was analyzed by gas chromatography and expressed in the molar amount of a gas which can be generated per 1 g of plastic (raw mass) used in the test. The PET raw material in the form of pellets generated only 9.381 mmol/g-PET of hydrogen, whereas the pulverized PET raw material in the form of powder having a diameter of less than 200 μm generated 23.39/g-PET of hydrogen, which confirmed that the production amount of hydrogen increases as the surface area of the plastic raw material reacting with NaOH and H₂O increases.

### Comparative Example 1-3

After 10 g of a glass fiber reinforced epoxy substrate (MCL-E-67 manufactured by Hitachi Chemical Co., Ltd.) having the composition shown in Table 1 below and covered with copper on both sides, i.e., a sample as a waste electronic component including metal, etc., cut into a square of 5 mm each side and 100 g of potassium carbonate were put into a 1,000 cm³ reactor, the temperature was raised while a nitrogen gas was allowed to flow at 160 cm³/min. Immediately after the temperature of the reactor reached approximately 100° C., steam was introduced at 1.0 g/min and the temperature was raised to a predetermined temperature at intervals of about 20 minutes. The temperature inside the reactor reached 625° C. or 675° C. and was maintained for 60 minutes. Then, the reactor was cooled and the resultant product was taken out. All products flowing out of the reactor during the reaction were cooled to room temperature by passing through a stainless steel pipe dipped in ice water and then separated into water, tar-like substances, and gas products. Thereafter, the gas products were captured in a gas bag. Table 2 below shows the yield of pyrolyzates from the epoxy substrate, and it was confirmed that the pyrolyzates include hydrogen, carbon monoxide, methane, carbon dioxide, tar-like substances, and carbon residues. The carbon residues were heavy organic substances attached to copper or glass fibers recovered by removing potassium carbonate by washing solid products remaining in the reactor after the reaction with water, and the yield of the carbon residues was 1.8%.

TABLE 1

| C | H | N | O(diff) | Br | Cu | glass |
|---|---|---|---|---|---|---|
| 21.7 | 2.2 | 0.5 | 5.1 | 7.4 | 14.9 | 48.2 |

TABLE 2

| | Reaction temperature (° C.) | | | | | | | |
|---|---|---|---|---|---|---|---|---|
| | 625 | | | | 675 | | | |
| Addition | 0.0 | 5.0 | 10.0 | 20.0 | 0.0 | 5.0 | 20.1 | 100.2 |
| amount of | | | | | | | | |
| potassium | | | | | | | | |
| carbonate (g) | | | | | | | | |
| Hydrogen | 1.9 | 3.0 | 5.6 | 8.3 | 2.5 | 5.0 | 7.3 | 11.1 |
| Carbon | 7.7 | 3.7 | 6.0 | 16.1 | 10.4 | 7.8 | 11.4 | 13.8 |
| monoxide | | | | | | | | |
| Methane | 0.4 | 0.5 | 0.3 | 0.7 | 0.4 | 0.8 | 0.7 | 0.9 |
| Carbon dioxide | 28.7 | 18.7 | 35.2 | 104.6 | 13.1 | 73.7 | 75.0 | 150.0 |
| Carbon residue | 5.2 | 3.3 | 4.3 | 1.7 | 6.6 | 3.1 | 2.4 | 1.8 |

When the amount of the product of Example 1-1 was compared with the amount of the product of Comparative Example 1-3 (reaction temperature: 675° C., addition amount of potassium carbonate: 100.2 g), the compositions of hydrogen in the products of Example 1-1 were 73.49% (PMMA) and 94.47% (PET), respectively, and the composition of hydrogen in the product of Comparative Example 1-3 was 6% (yield: 11.1%). In Example 1-1, carbon dioxide was captured as carbonate due to the presence of NaOH during the reaction, and, thus, the compositions of carbon dioxide was as low as 3.05% (PMMA) and 2.13% (PET). However, in Comparative Example 1-3, the composition of carbon dioxide was as high as 84% (yield: 150%).

### Example 1-2: Gasification of Plastic (Epoxy Resin) Through Alkaline Thermal Treatment (ATT)

At 1 atm pressure, 0.1 g of plastic (epoxy resin (C₂₁H₂₄O₄)), 0.5 g of NaOH, and 0.5 g of H₂O were put into a ceramic boat reactor and then, a reaction was carried out in a temperature range of 100° C. to 950° C. (heating rate: 2° C./min) while steam was supplied at a flow rate of 23 μL/min. Nitrogen was used as a carrier gas (flow rate: 50 mL/min). The structural formula of the epoxy resin (C₂₁H₂₄O₄) used above is the same as Chemical Formula 1 below:

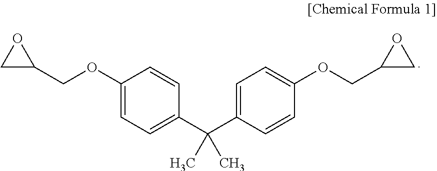 [SMILES: CC(C)(c1ccc(OCC2CO2)cc1)c1ccc(OCC2CO2)cc1]

The reaction scheme of epoxy resin (C₂₁H₂₄O₄), NaOH, and H₂O during the reaction is as follows, and a mass ratio of the reactants is C₂₁H₂₄O₄:NaOH:H₂O=1:4.94:0.9:

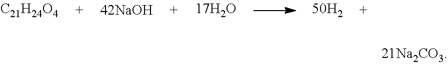

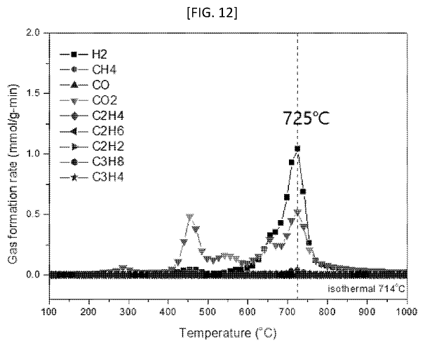

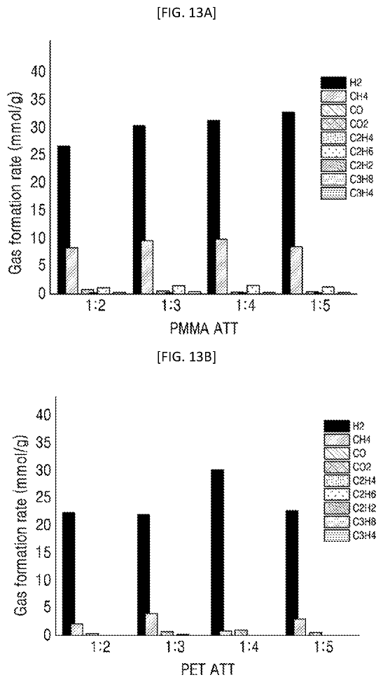

Thereafter, the generated gas was analyzed in the same manner as in Example 1-1, and the results are shown in FIG. 8 and FIG. 9. FIG. 8 and FIG. 9 show the production amount of a gas generated from epoxy resin (C₂₁H₂₄O₄) and a gas production rate depending on a reaction temperature, respectively. When the reaction was carried out with the temperature raised to 700° C., the production amount of hydrogen was 66.21 mmol H₂/g and the purity of hydrogen was 80.67%, which confirmed the generation of hydrogen through alkali thermal treatment of the epoxy resin (C₂₁H₂₄O₄).

### Example 1-3: Gasification of Plastic (PET) Through ATT Using Ca(OH)₂

At 1 atm pressure, 0.1 g of plastic (PET), 0.4 g of Ca(OH)₂, and 0.4 g of H₂O were put into a ceramic boat reactor and then, a reaction was carried out in a temperature range of 100° C. to 600° C. (heating rate: 2° C./min) while steam was supplied at a flow rate of 23 μL/min. Nitrogen was used as a carrier gas (flow rate: 50 mL/min). The reaction scheme of PET (C₁₀H₈O₄), Ca(OH)₂, and H₂O during the reaction is as follows, and a mass ratio of the reactants is C₁₀H₈O₄:Ca(OH)₂:H₂O=1:3.86:0.56:

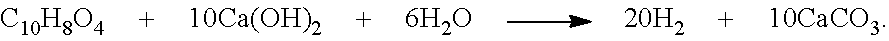

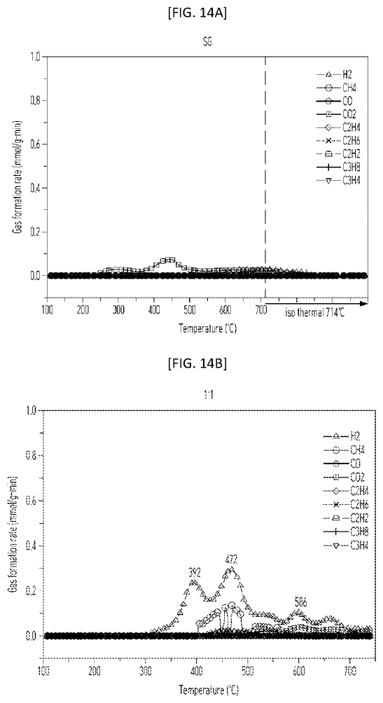

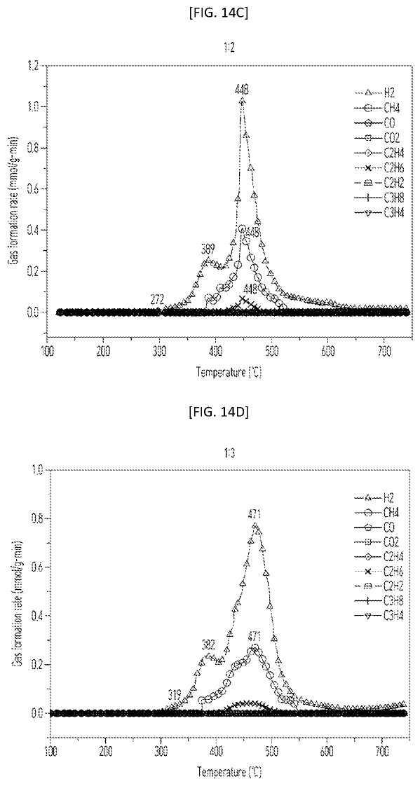

Thereafter, the generated gas was analyzed in the same manner as in Example 1-1, and the results are shown in FIG. 10 and FIG. 11.

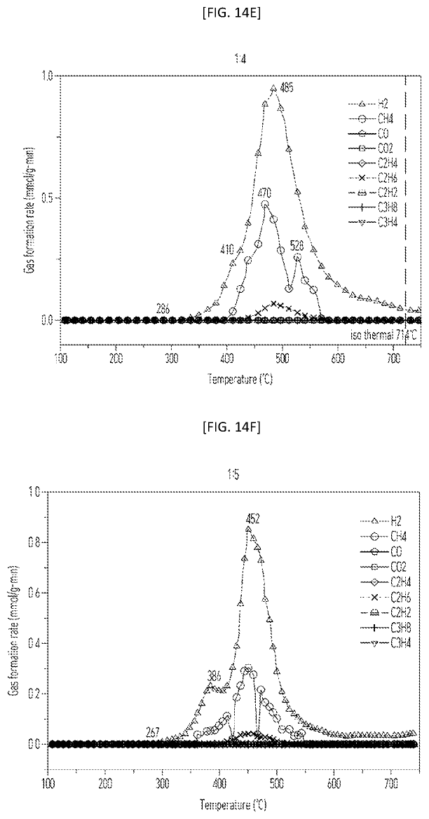

Referring to FIG. 10, when Ca(OH)₂ was used, the production amount of hydrogen was 8.11 mmol/g, the purity of hydrogen was 83.66%, and the production amount of CO₂ was 0.8039 mmol/g (CO₂ production selectivity: 8.29%), which confirmed the generation of hydrogen through ATT using Ca(OH)₂. FIG. 11 shows a gas production rate depending on a reaction temperature, and the production amount of hydrogen was highest at 550° C. and the optimal reaction temperature range was from about 350° C. to about 600° C. It was confirmed that although not shown in the drawings, the production amount of CO₂ increased due to pyrolysis of a salt CaO₃ at a temperature of about 600° C. or more. Even when NaOH was used as an alkali, it was confirmed that the production amount of CO₂ increased due to pyrolysis of a salt Na₂CO₃ at a temperature of about 750° C. or more. In this case, CO₂ was not generated through alkaline thermal treatment, but CO₂ captured as carbonate or bicarbonate was re-released through pyrolysis. FIG. 12 is a graph showing a gas production rate depending on a reaction temperature in gasification of PET through SG, and it can be seen that hydrogen gas is generated at a high temperature of about 600° C. to 800° C.

### Example 1-4: Gasification of Plastic (PET and PMMA) Through ATT Depending on Mass Ratio of Plastic and Alkali (NaOH)

At 1 atm pressure, a reaction was carried out while a mass ratio of plastics (PET and PMMA) and alkali was adjusted to 1:1, 2, 3, 4, and 5 by fixing the mass of PET and PMMA to 0.1 g and changing the mass of NaOH and H₂O to 0.1 g, 0.2 g, 0.3 g, 0.4 g, and 0.5 g, respectively. Also, steam gasification (SG) was carried out without the addition of an alkali under the same conditions. Besides, the reaction was carried out in a temperature range of 100° C. to 700° C. (heating rate: 2° C./min) while steam was supplied at a flow rate of 23 μL/min. Nitrogen was used as a carrier gas (flow rate: 50 mL/min).

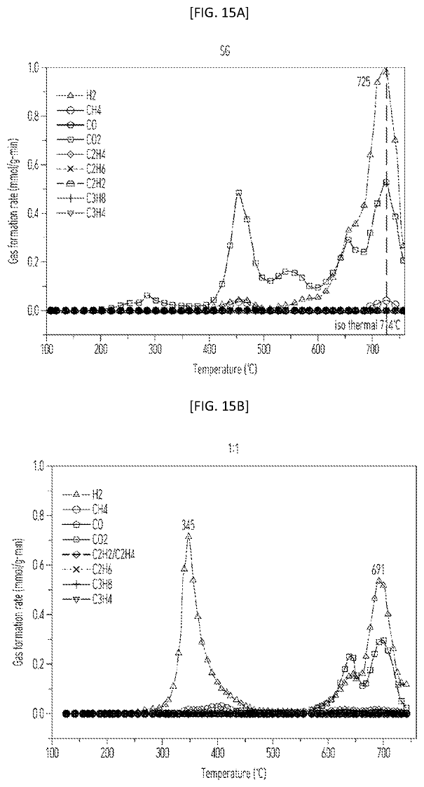

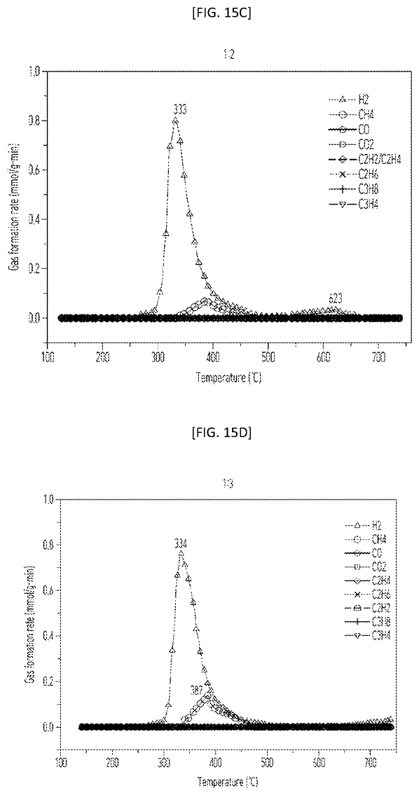

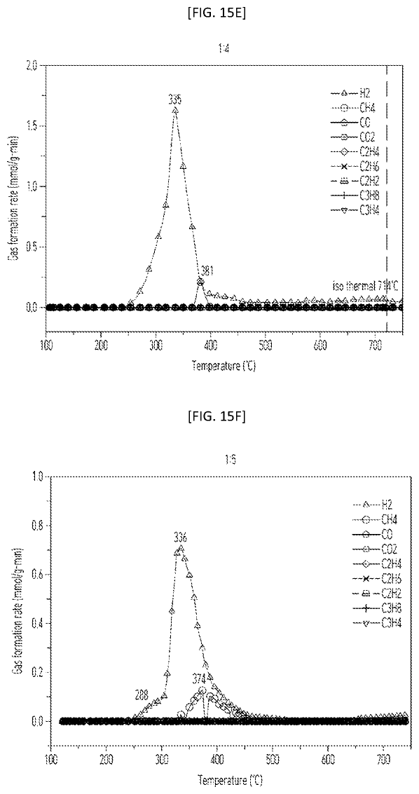

Thereafter, the generated gas was analyzed in the same manner as in Example 1-1, and the results are shown in FIG. 13A to FIG. 15F. Referring to FIG. 13A, the production amount of hydrogen generated from PMMA slightly increased as the mass of NaOH in PMMA increased. Referring to FIG. 13B, the production amount of hydrogen generated from PET was highest at PET:NaOH=1:4. FIG. 14A to FIG. 14F and FIG. 15A to FIG. 15F show gas production rates depending on a reaction temperature at a mass ratio of PMMA:NaOH and a mass ratio of PET:NaOH, respectively. It was confirmed that as for PMMA and PET, the production amount at each temperature was slightly different at a mass ratio of 1:2 to 1:5, and PMMA and PET generated H₂ at similar reaction temperatures. Also, referring to FIG. 15A and FIG. 15B, PET generated H₂ at a high temperature of about 700° C. or more under the SG reaction conditions and the ATT conditions with a mass ratio of PET:NaOH=1:1, which confirmed a low hydrogen gasification efficiency. The reaction temperature is significantly higher than a reaction temperature range (from about 300° C. to about 450° C.) for the generation of hydrogen at the other mass ratios of PET:NaOH shown in FIG. 15C to FIG. 15F.

### Example 2-1: Gasification of Plastic (PE and PP) not Containing Oxygen Through Alkaline Thermal Treatment (ATT)

### 1) Thermal Oxidation Pretreatment of Plastic

PE was thermally oxidized at each temperature of 150° C., 175° C., 200° C., 250° C., 300° C., 350° C., and 400° C. for 50 hours. Also, PP was thermally oxidized at each temperature of 150° C., 175° C., 200° C., 300° C., and 400° C. for 50 hours.

### 2) Gasification Through Alkaline Thermal Treatment

PE or PP thermally oxidized as described in paragraph 1), NaOH, and water were added into a ceramic boat reactor and then, alkaline thermal treatment was carried out in a temperature range of 100° C. to 600° C. while 7.59 mL of steam was supplied (flow rate: 23 μL/min). Nitrogen was used as a carrier gas (flow rate: 50 mL/min), and the gas produced after the reaction was allowed to pass through a cooler, captured in a gas bag and analyzed by gas chromatography. In this case, a mass ratio of plastic (PE or PP) and NaOH is 1:5.

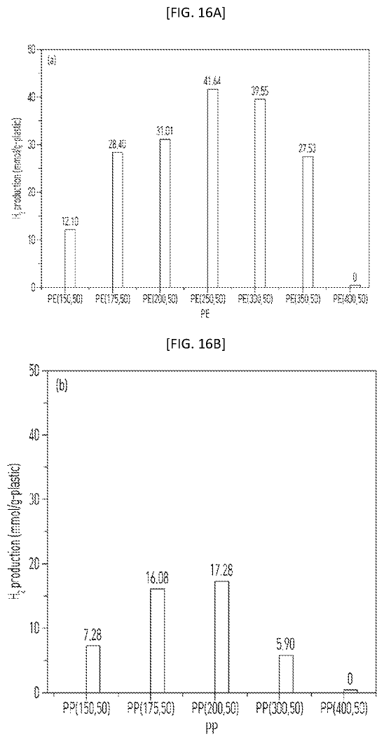

FIG. 16A and FIG. 16B show the production amounts of hydrogen (molar amounts of hydrogen per 1 g of plastic) depending on thermal oxidation conditions (thermal oxidation temperature and time) of respective plastics in gasification through alkaline thermal treatment, and these values were obtained by compensating for weight losses caused by thermal oxidation. Referring to FIG. 16A, the production amount of hydrogen from PE was as high as 39 mmol/g at 250° C. and 300° C. as compared to temperatures of 150° C. to 200° C. and 350° C. Referring to FIG. 16B, the production amount of hydrogen from PP was as high as 16 mmol/g at 175° C. and 200° C. Also, both PE and PP were completely combusted at 400° C.

### Example 2-2: Gasification Through ATT Depending on Thermal Oxidation Time

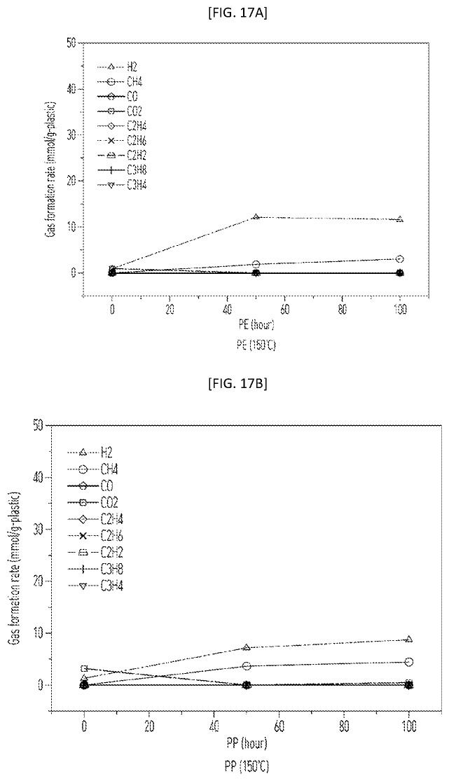

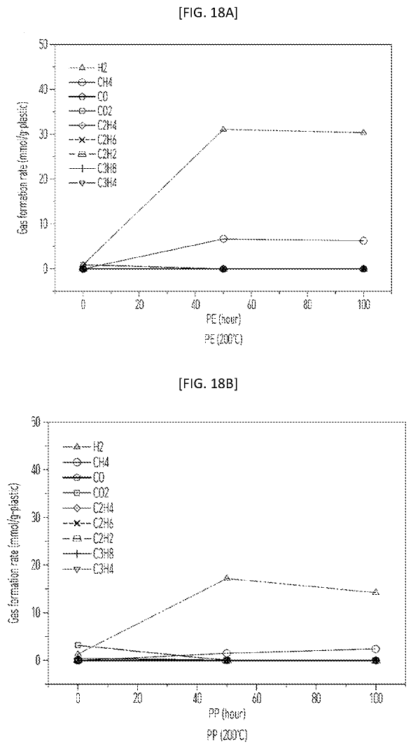

In Example 2-1, an additional test was conducted under thermal oxidation conditions set to (150° C., 50 hours), (150° C., 100 hours), (200° C., 50 hours), and (200° C., 100 hours). Referring to FIG. 17A and FIG. 17B, PE and PP generated approximately the same amount of hydrogen at a temperature of 150° C. even when the thermal oxidation time increased from 50 hours to 100 hours. Therefore, it was confirmed that when plastic not containing oxygen was pretreated through thermal oxidation for 50 hours or more 50, the production amount of hydrogen was increased. Referring to FIG. 18A and FIG. 18B, the production amount of hydrogen at a temperature of 200° C. was slightly decreased when the thermal oxidation time was 100 hours as compared to when the thermal oxidation time was 50 hours. This is because of an increase in the weight gradient of plastic during thermal oxidation, but not relevant to a hydrogen generation efficiency.

### Comparative Example 2-1

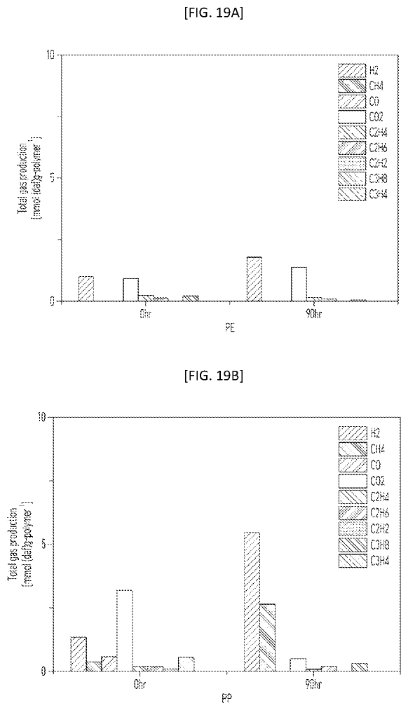

In Example 2-1, an additional test was conducted under thermal oxidation conditions set to (100° C., 90 hours). Referring to FIG. 19A and FIG. 19B, it can be seen that the production amounts of hydrogen from PE and PP are as low as about 3 mmol/g and about 5 mmol/g, respectively.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

1. A method of generating hydrogen using plastic containing oxygen, comprising:
subjecting the plastic containing oxygen to a thermal treatment reaction with hydroxide and water vapor to obtain hydrogen,
wherein an amount of generated CO₂ is 10 mol % or less of the total generated gas.

2. The method of claim 1,
wherein the method comprises
(a) supplying the plastic and the hydroxide to a reactor; and
(b) obtaining hydrogen and a carbonate product through the thermal treatment reaction while introducing the water vapor into the reactor.

3. The method of claim 2,
wherein the carbonate product is carbonate or bicarbonate.

4. The method of claim 1,
wherein the plastic includes at least one selected from acrylic resin, polyethylene terephthalate (PET), and epoxy resin.

5. The method of claim 1,
wherein the hydroxide includes at least one selected from KOH, NaOH, LiOH, Ca(OH)₂, Mg(OH)₂, and NH₄OH.

6. The method of claim 1,
wherein the thermal treatment reaction is performed at a temperature of 100° C. to 600° C.

7. The method of claim 1,
wherein the thermal treatment reaction is performed at atmospheric pressure.

8. The method of claim 1,
wherein a mass ratio of the plastic and the hydroxide is 1:2 to 1:5.

9. The method of claim 1,
wherein a purity of the generated hydrogen obtained by the method is 70% or more.

10. The method of claim 1,
wherein an amount of the generated hydrogen obtained by the method is 5 mmol or more per 1 g of plastic.

11. A method of generating hydrogen using plastic not containing oxygen, comprising:
thermally oxidizing the plastic not containing oxygen to obtain thermally oxidized plastic; and
subjecting the thermally oxidized plastic to a thermal treatment reaction with hydroxide and water vapor to obtain hydrogen.

12. The method of claim 11,
wherein the plastic is polyethylene, and
wherein the thermal oxidation is performed at a temperature of 150° C. to 350° C.

13. The method of claim 11,
wherein the plastic is polypropylene, and
wherein the thermal oxidation is performed at a temperature of 150° C. to 300° C.

14. The method of claim 11,
wherein the hydroxide includes at least one selected from KOH, NaOH, LiOH, Ca(OH)₂, Mg(OH)₂, and NH₄OH.

15. The method of claim 11,
wherein the thermal treatment reaction is performed at a temperature of 100° C. to 700° C.

16. The method of claim 11,
wherein the thermal treatment reaction is performed at atmospheric pressure.

17. The method of claim 11,
wherein a mass ratio of the plastic and the hydroxide is 1:2 to 1:6.

18. The method of claim 12,
wherein an amount of the generated hydrogen is 25 mmol or more per 1 g of plastic.

19. The method of claim 13,
wherein an amount of the generated hydrogen is 10 mmol or more per 1 g of plastic.
